(19) United States
(12) Patent Application Publication
(10) Pub. No.: US 2024/0142090 A1
(43) Pub. Date: May 2, 2024

(54) SYSTEMS AND METHODS FOR DETERING THEFT OF INTERNAL COMPONENTS OF STREETLIGHTS

(71) Applicants: Dave Fellon, St. Paul, MN (US); Jace Fellon, St. paul, MN (US)

(72) Inventors: Dave Fellon, St. Paul, MN (US); Jace Fellon, St. paul, MN (US)

(21) Appl. No.: 18/497,829

(22) Filed: Oct. 30, 2023

Related U.S. Application Data
(60) Provisional application No. 63/500,151, filed on May 4, 2023.
(60) Provisional application No. 63/421,008, filed on Oct. 31, 2022.

(51) Int. Cl. F21V 15/00; F21S 8/08; G08B 15/00

(52) U.S. Cl. CPC F21V 15/005; F21S 8/085; G08B 15/001

(57) ABSTRACT

A streetlight apparatus and method involves use of an anti-theft material for deterring theft of internal components of a streetlight. In some examples, the anti-theft material includes an expandable foam that expands to fill at least part of an internal space of the streetlight. In some examples, the anti-theft material includes a permanent ink that marks one or more internal components of the streetlight. The anti-theft material may be dispensed inside of the streetlight before someone tampers with the streetlight or once tempering is detected. In some examples, the anti-theft material includes a foam-expandable bag.

This application claims the benefit of U.S. Provisional Patent Application Ser. No. 63/500,151, filed May 4, 2023, and U.S. Provisional Patent Application Ser. No. 63/421,008, filed Oct. 31, 2022, both of which are incorporated herein by reference.

### TECHNICAL FIELD

The disclosure relates generally to streetlights and more particularly to systems and methods for deterring theft of internal components of streetlights.

### BACKGROUND

Streetlights typically include a light fixture on top of a tall pole. They are usually installed along streets or walkways. Often there is a long series of streetlights interconnected by electrical wires for powering them. If the wires are made of copper, or some other valuable material, the wires can be susceptible to theft. What would be desirable are systems and methods for deterring theft of internal components such as wires of streetlights and wires between streetlights.

### SUMMARY

The present disclosure generally pertains to streetlights and more particularly to systems and methods for deterring theft of internal components of streetlights.

An example streetlight includes a base, a tubular pole extending upward from the base, a light fixture supported by the tubular pole, a conduit leading to the base, and a plurality of wires some of which extend out from an interior space of the conduit into an interior space of the base and through at least part of an interior space of the tubular pole to provide power to the light fixture. An example method includes providing an anti-theft material in an unsolidified state into the interior space of the base, the interior space of the tubular pole and/or the interior space of the conduit, followed by providing the anti-theft material in the unsolidified state in at least part of the interior space of the base, the interior space of the tubular pole and/or the interior space of the conduit, and once provided, the anti-theft material solidifies to provide a deterrent to stealing one or more internal components of the streetlight. It is contemplated that the anti-theft material can be any suitable anti-theft material such as an expandable foam or a permanent ink.

Another example streetlight includes a base defining a chamber therein, a removable cover plate attached to the base to cover the chamber, a tubular pole extending upward from the base, a light fixture supported by the tubular pole, and a conduit leading to the base. An example method includes removing the cover plate from the base, inserting a foam-expandable bag with a foam material that is in an unsolidified state into the base, the tubular pole and/or the conduit, wherein the foam-expandable bag is configured to expand and then solidify in the streetlight to provide a tamper resistance layer to one or more internal components of the streetlight, and reattaching the cover plate to the base. Another example method includes removing the cover plate from the base, positioning an electrical wire such that the electrical wire is spaced apart from internal walls of the base and/or tubular pole in at least one area, using a wand to inject a foam material that is in an unsolidified state into the base and/or the tubular pole such that the foam material once solidified engages the electrical wire in the at least one area, and reattaching the cover plate to the base.

In another example, a streetlight includes a base defining a chamber therein, a removable cover plate attached to the base to cover the chamber, a tubular pole extending upward from the base, a light fixture supported by the tubular pole, a conduit leading to the base, one or more electrical wires extending through the conduit, the base and at least part of the tubular pole to provide power to the light fixture, and a solidified foam material hindering access to at least some of the electrical wires inside of the base, conduit and/or tubular pole. In some instances, the solidified foam material is an expandable foam material that expanded from an unexpanded state to an expanded state inside of the base, conduit and/or tubular pole before solidifying.

The preceding summary is provided to facilitate an understanding of some of the features of the present disclosure and is not intended to be a full description. A full appreciation of the disclosure can be gained by taking the entire specification, claims, drawings and abstract as a whole.

### BRIEF DESCRIPTION OF THE DRAWINGS

The disclosure may be more completely understood in consideration of the following description of various illustrative embodiments of the disclosure in connection with the accompanying drawings in which:

FIG. 1 is a front view of an example modified streetlight next to an example sponsor;

FIG. 2 is a front view of an example streetlight before being modified;

FIG. 3 is a front view similar to FIG. 2 but showing some example wiring and conduit;

FIG. 4 is a front view of a series of example streetlights;

FIG. 5 is a cross-sectional front view of a lower section of the streetlight shown in FIG. 1;

FIG. 6 is a cross-sectional front view similar to FIG. 5 but showing the streetlight after being modified;

FIG. 7 is a front view of the streetlight being modified;

FIG. 8 is a perspective view of an example sponsor paying an example entity to help cover the cost of maintaining a streetlight;

FIG. 9 is a front view of a streetlight being modified;

FIG. 10. is a cross-sectional view taken along line 10-10 of FIG. 9;

FIG. 11 is a front view of an example modified streetlight;

FIG. 12 is a front view similar to FIG. 11 but with a cover plate being removed from the streetlight and an example sensor emitting an alarm signal;

FIG. 13 is a left side view of an example streetlight being modified;

FIG. 14 is a left side view similar to FIG. 13 but showing the streetlight after it is modified;

FIG. 15 is a left side view similar to FIG. 15 but showing the cover plate being removed and the sensor emitting an alarm signal;

FIG. 16 is a collection of views showing an unmodified conduit of the streetlight, parts for plugging the conduit, and a set of tools for removing the plug;

FIG. 17 is a cross-sectional view showing a method step for plugging a conduit;

FIG. 18 is a cross-sectional view showing another method step for plugging a conduit;

FIG. 19 is a cross-sectional view showing the conduit plugged using the method steps of FIGS. 17 and 18;

FIG. 20 is a cross-sectional view showing the use of a set of tools for removing the plug from the conduit;

FIG. 21 is a cross-sectional view showing the set of tools configured for removing the plug from the conduit;

FIG. 22 is a cross-sectional view similar to FIG. 21 but showing the set of tools being used for removing the plug from the conduit;

FIG. 23 is a cross-sectional view similar to FIG. 23 but showing the set of tools for removing the plug;

FIG. 24 is a cross-sectional view similar to FIG. 23 but with the set of tools removed and the plug being manually pulled out farther;

FIG. 25 is a front view showing an example cover plate being removed from the base of a streetlight;

FIG. 26 shows a foam-expandable bag being activated by manual manipulation;

FIG. 27 is a front view showing the foam-expandable bag being inserted into the base of the streetlight;

FIG. 28 is a front view showing the cover plate being reattached to the base while the foam-expandable bag expands;

FIG. 29 is a front view showing the foam-expandable bag continuing to expand while the cover plate is attached to the base; and

FIG. 30 is a left side view of a streetlight with its base partially filled with a foam-expandable bag.

While the disclosure is amendable to various modifications and alternative forms, specifics thereof have been shown by way of example in the drawings and will be described in detail. It should be understood, however, that the intention is not to limit the disclosure to the particular illustrative embodiments described herein. On the contrary, the intention is to cover all modifications, equivalents, and alternatives falling within the spirit and scope of the disclosure.

### DESCRIPTION

The following description should be read with reference to the drawings wherein like reference numerals indicate like elements throughout the several views. The description and drawings show several examples that are meant to be illustrative of the disclosure.

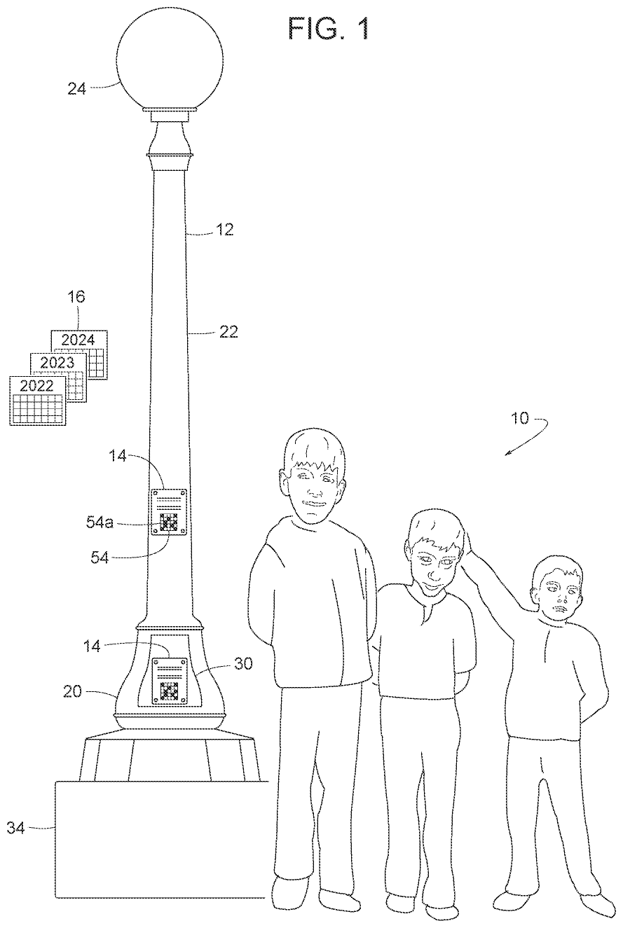

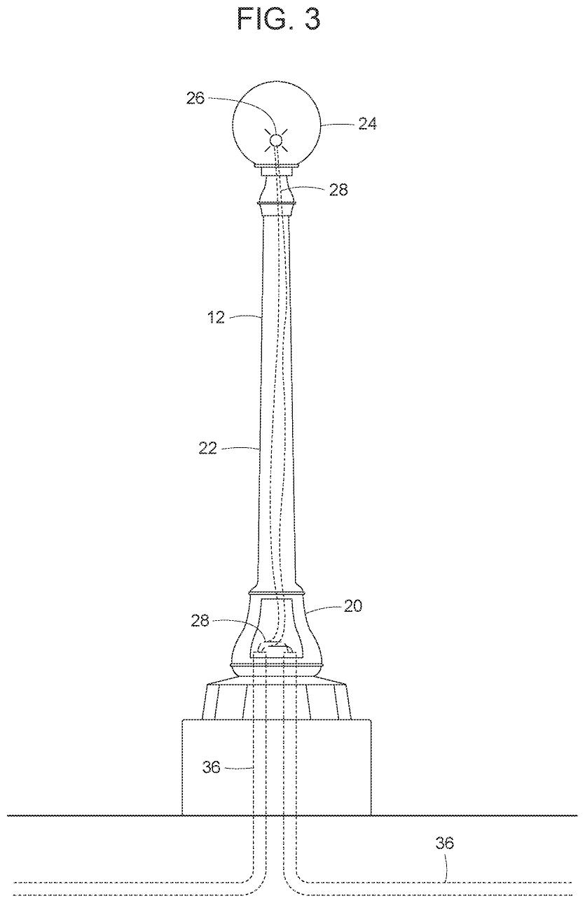

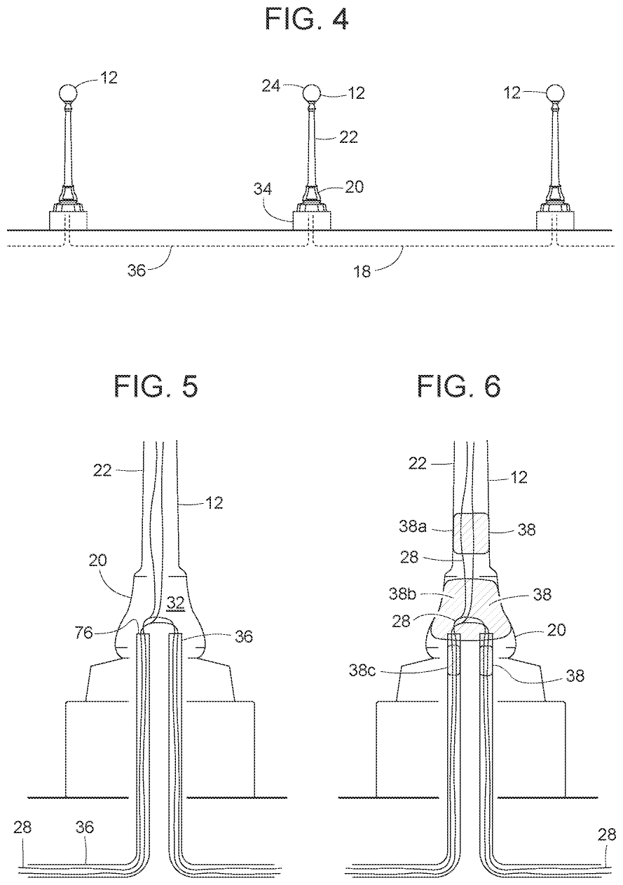

FIGS. 1-24 illustrate various apparatuses and methods for thwarting the theft of wires and/or other internal components of streetlights. With respect to FIG. 1, and in some examples, streetlight 12 includes a hollow base 20, a tubular pole 22 extending upward from base 20, a light fixture 24 on top of pole 22, a lamp 26 (e.g., incandescent bulb, halogen bulb, LED, etc.) in light fixture 24, and at least one electrical wire 28 leading to lamp 26. Examples of wire 28 include one or more insulated “hot” wires, one or more insulated neutral wires, and one or more insulated or non-insulated ground wires. Some examples of base 20 include a cover plate 30 that can be removed for accessing a chamber 32 inside of base 20. For support, some examples of base 20 are anchored to a concrete foundation 34. In some examples, some parts of wire 28 extend through a conduit 36. Some sections of conduit 36 can be buried underground, and other sections can extend up into chamber 32 of base 20. In some examples, wire 28 includes multiple interconnected wire segments that may vary in length and wire gauge, and the actual wiring configuration can differ from what is shown in the drawings.

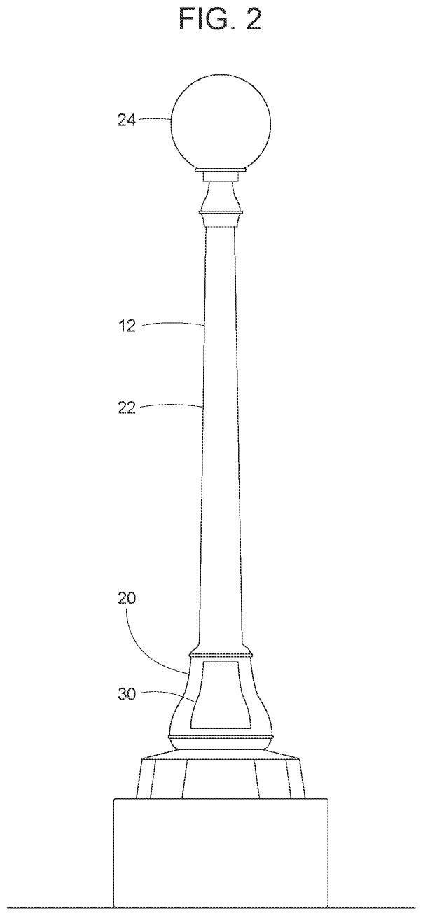

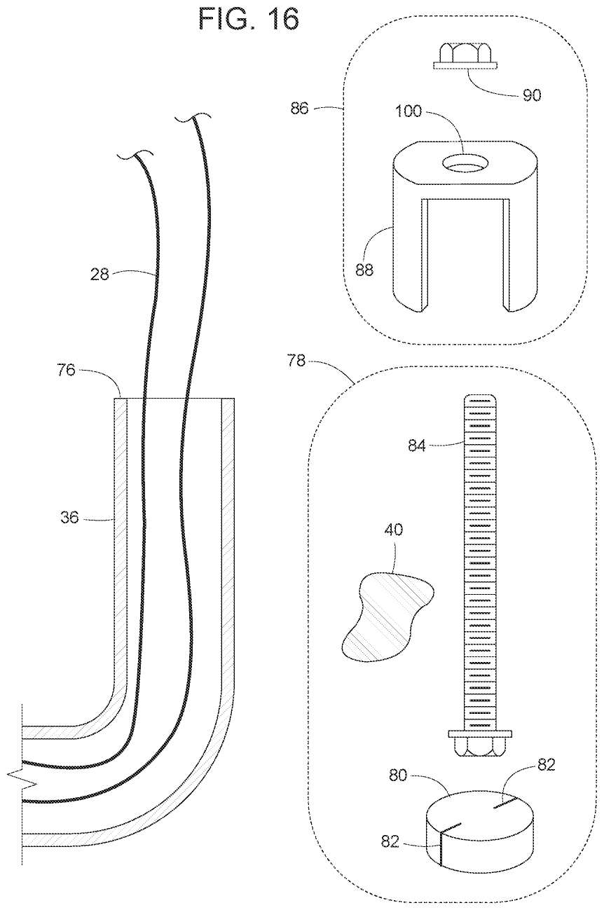

FIGS. 2-5 show streetlight 12 prior to being modified by the present disclosure. FIG. 6 shows one or more plugs 38 (e.g. plugs 38a, 38b and 38c) having been inserted to inhibit the tampering or theft of wire 28 and/or other internal components in pole 22, base 20 and/or conduit 36. Some examples of plug 38 include expanded foam (e.g., GREAT STUFF by DuPont or 3M products such as AUTOMIX and 8458 foam), epoxy 40 (FIGS. 16-24), a mechanical obstruction, and/or various combinations thereof.

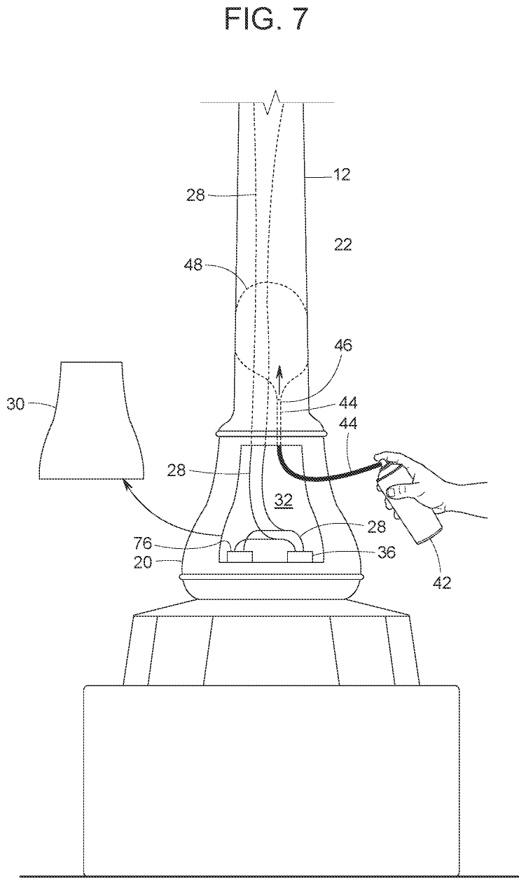

FIG. 7 shows an example means for creating plug 38. In the illustrated example, cover plate 30 is removed and a pressurized can 42 (or other foam source) and curved wand 44 with a discharge nozzle 46 inject expanding foam 48 into pole 22, base 20 and/or conduit 36. When expanded, the foam sets (e.g. solidifies) to create a plug 38. Plug 38 at least partially surrounds wire 28. This makes it more difficult for thieves to steal wire 28.

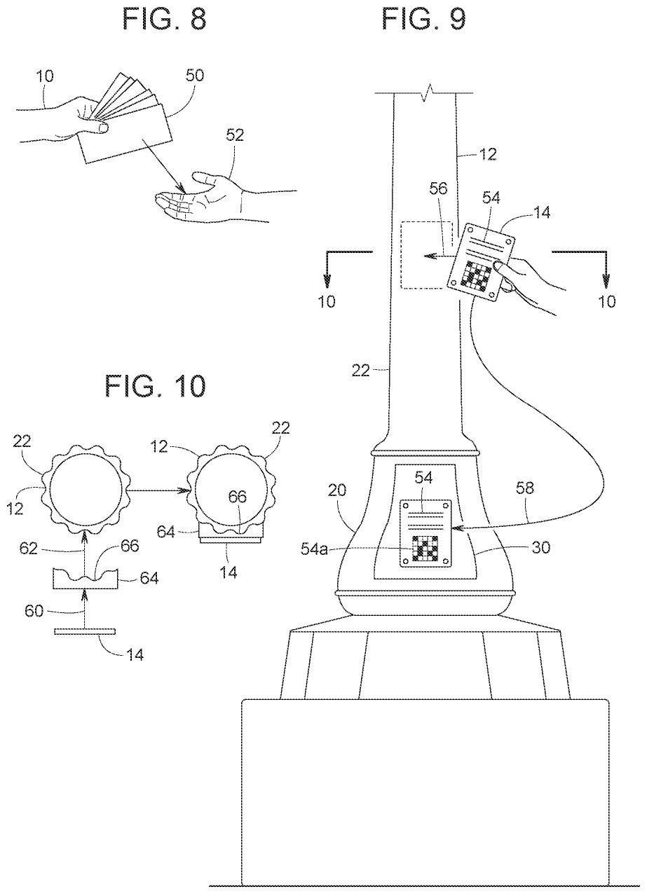

FIG. 8 shows an illustrative sponsorship program. In this example, sponsor 10 pays a sponsorship fee 50 to help cover the cost of modifying streetlight 12 and/or covering at least some maintenance cost of one or more streetlights 12. In some examples, the sponsorship fee 50 includes a plurality of payments (e.g., six bills as shown in FIG. 8) distributed over a predetermined period 16 (e.g., three years). In some examples, the length of the predetermined period 16 is based on the amount of the sponsorship fee 50.

In some examples, an entity 52 receiving the sponsorship fee 50 attaches a notification 14 to streetlight 12, wherein the notification 14 provides recognition 54 of sponsor 10. Some examples of recognition 54 include the name of sponsor 10, a QR code 54a associated with sponsor 10, a website address of sponsor 10, a telephone number of sponsor 10, a picture of sponsor 10, etc. Some examples of entity 52 (that receives sponsorship fee 50) include a municipality, a land property owner, an individual, an organization, etc.

Arrows 56 and 58 of FIG. 9 and arrows 60 and 62 of FIG. 10 represent examples of attaching notification 14 to streetlight 12. In some examples, an adaptor 64 with a contoured surface 66 matching the contour of pole 22 or cover plate 30 helps fit a generally flat notification 14 to streetlight 12.

FIG. 1 shows a sponsor 10 (e.g., an individual, a group, a family, a Scout troop, an organization, etc.) supporting the maintenance of an example streetlight 12. A notification 14 (sign, plaque, sticker, label, etc.) provides recognition of sponsor 10, which has paid to help cover the cost of maintaining or repairing one or more streetlights 12 over a predetermined period of time 16 (e.g. 1 year).

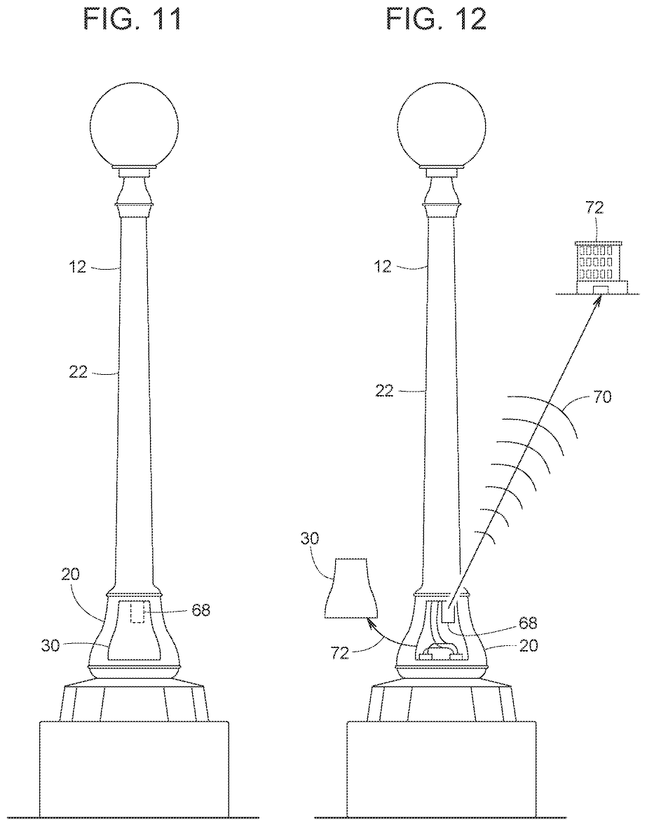

In some examples, as shown in FIGS. 11-15, a sensor 68 is added to streetlight 12. In some cases, sensor 68 provides an alarm signal 70 in response to someone possibly tampering with streetlight 12. In some examples, alarm signal 70 is transmitted to a remote location 72 (e.g., police department, city street department, sponsor 10, etc.). The term, “remote” means external to the streetlight 12 and at least 10 feet away. In some examples, alarm signal 70 is transmitted by electromagnetic radiation (e.g., radio signal such as a cellphone signal (3G, 4G, 5G), BLE, WiFi, a mesh network, etc.). In some examples, alarm signal 70 may be transmitted over a wired network. In some cases, alarm signal 70 may be transmitted over power lines 28 via Power Line Communication (PLC). In some cases, the sensor 68 may be powered by power supplied over wires 28. In some cases, the sensor 68 may be powered by batteries. In some cases, the sensor 68 may be powered by power received over wires 28 with backup power provided by batteries.

In some cases, the sensor 68 may cause an audible alarm in response to someone possibly tampering with streetlight 12. In some cases, the sensor 68 may cause a visual alarm in response to someone possibly tampering with streetlight 12.

In some cases, the sensor 68 may cause a visual alarm by temporarily interrupt power to the lamp 26 of the streetlight in a predetermined pattern, causing the lamp 26 to flash on and off at a predetermined period and duty cycle. In some cases, temporarily interrupting power to the lamp 26 in a predetermined pattern produces a detectable signal on the wires 28, which can be detected by a monitoring station remote from the streetlight 12 and reported to an entity overseeing the maintenance/security of the streetlights 12. In some cases, neighboring streetlights may detect the detectable signal on the wires 28 and in response temporarily interrupt power to their lamps in a predetermined pattern, causing the neighboring streetlights to also flash on and off. These are just examples.

In some cases, the sensor 68 may include a deployable payload that can be deployed by the sensor 68 in response to detecting someone tampering with the streetlight 12. For example, the sensor 68 may deploy a payload of expandable foam to form a plug about the wires 28 in response to detecting someone tampering with the streetlight 12. In another example, the sensor may deploy an exploding ink tag that when deployed disperses a permanent ink that covers the thief, wires 28 and/or other internal components that the police, security personnel and/or wire salvage yards will recognize as associated with theft. It is contemplated that the deployment of the payload by the sensor 68 may be disabled by an authorized maintenance worker, such as by providing a valid security code to the sensor 68 (e.g. via a Bluetooth connected cell phone, a keypad, and/or in any other suitable manner).

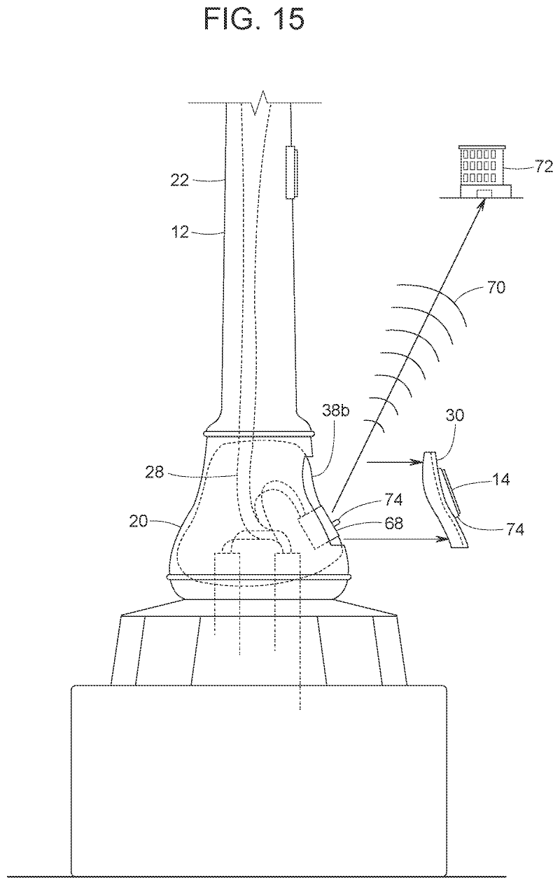

Some examples of sensor 68 include a light sensor that detects sunlight or a flashlight when cover plate 30 is removed (arrow 72 of FIG. 12), a limit switch with a spring-loaded button 74 (FIG. 15) that detects the removal of cover plate 30, a Hall Effect or motion sensor (e.g. accelerometer, gyroscope) that detects the removal of cover plate 30 and/or hammering on the streetlight, and a microphone responsive to a sound characteristic of hammering or breaking. These are just examples.

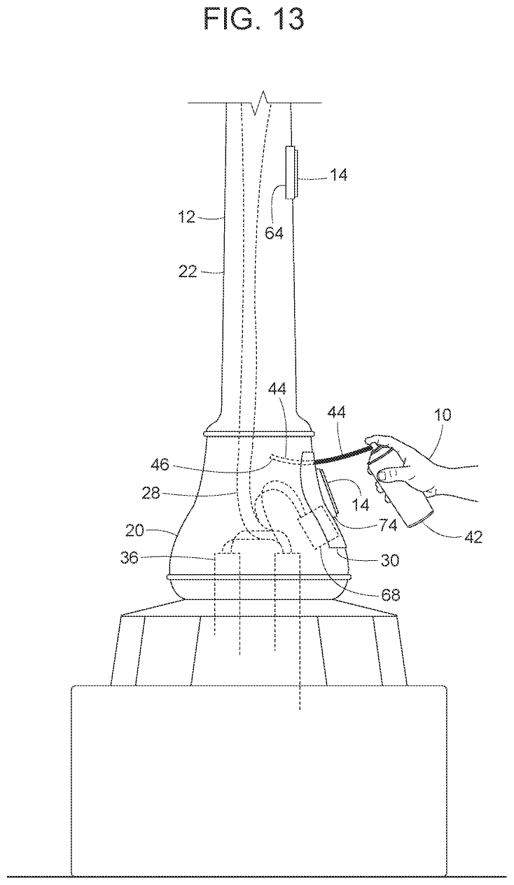

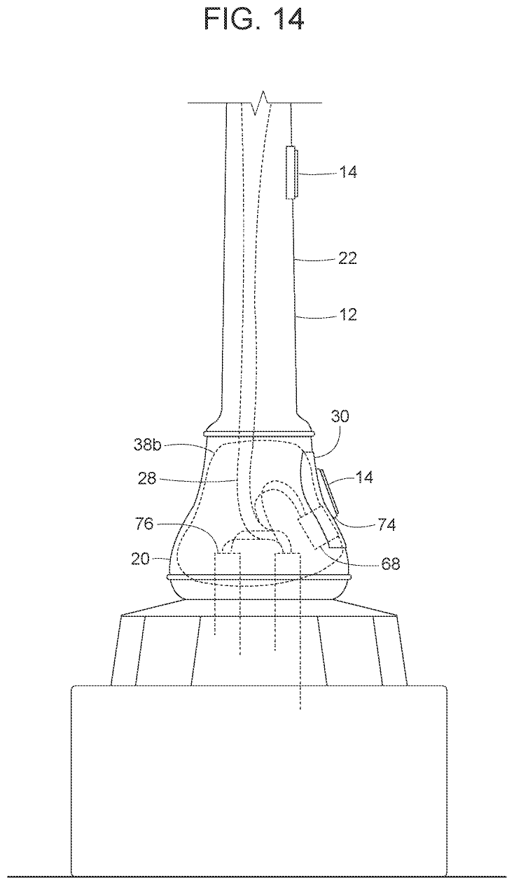

FIGS. 13-15 show one example method of installing sensor 68 and filling base 20 with plug 38 in the form of expanding foam. In this example, a non-hardening putty, screws or magnets hold sensor 68 up against a backside of cover plate 30. In this example, wand 44 is inserted through a small hole in cover plate 30 to inject expanding foam 48 into chamber 32 while cover plate 30 remains attached to base 20, as shown in FIG. 13. FIG. 14 shows the foam having set (e.g. solidified) to form plug 38b. Plug 38b fills most of chamber 32 and partially surrounds and bonds to sensor 68. If cover plate 30 is then later removed and pulled away from sensor 68, as shown in FIG. 15, sensor 68 detects outdoor ambient light or spring loaded button 74 extends in response to the separation of cover plate 30 from sensor 68. In either case, sensor 68 emits alarm signal 70 in response to cover plate 30 being removed.

In another example, the foam is not injected by wand 44 as shown in FIG. 13. Instead, the sensor 68 includes a payload of an anti-theft material such as an expandable foam or a permanent ink in an unsolidified state. In response to the sensor 68 detecting a condition that corresponds to someone tampering with the streetlight 12, the sensor 68 then causes the dispersing of the anti-theft material in at least part of the interior space of the base, the interior space of the tubular pole and/or the interior space of the conduit. Once the anti-theft material solidifies, the anti-theft material provides a deterrent to stealing one or more internal components of the streetlight.

The condition that corresponds to someone tampering with the streetlight may include, for example: removal of the cover plate that is removably attached to the streetlight to access the interior space of the base, the interior space of the tubular pole and/or the interior space of the conduit; a predetermined motion profile of at least part of the streetlight, such as a motion profile that indicates someone is hammering on the streetlight; a predetermined electrical profile of electrical signals on one or more of the plurality of wires, such as power no longer being delivered to the streetlight; a predetermined temperature change profile of at least part of the streetlight, such as a temperature change inside of the streetlight caused by the removal of the cover plate; a predetermined sound profile, such as a sound profile that corresponds to hammering and/or drilling on the streetlight; and a predetermined light profile, such as a change in ambient light inside of the streetlight caused by the removal of the cover plate. These are just examples.

In some examples, cover plate 30 is made mostly of plastic or some other material that is different than the metal of base 20. Plastic provides several benefits over a cover plate made of cast iron. One, plastic can be 3D printed or cast in acrylic using an inexpensive silicon mold made from the original cast iron cover plate 30. Two, plastic is weaker than iron, so if a vandal hammers on cover plate 30, the plastic material will likely breakaway before the more expensive iron base 20 can break. Three, a 3D printed or cast acrylic cover plate 30 can include an integral flat boss 74 for readily attaching notification 14. Four, a cover plate 30 if cast in clear acrylic would provide a window into chamber 32 to show the wires 28 inside are tamperproof, plus curious others might find it interesting just to see what's inside base 20.

FIGS. 16-24 show example structures and methods associated with plug 38c. Plug 38c is used for affixing one or more wires 28 within conduit 36 in the area where an upper end 76 of conduit 36 extends into chamber 32 of base 20. FIG. 16 shows plug 38c including a set of parts 78. The set of parts 78 include a foam disk 80 with slits 82 through which wires 28 can pass, an odd bolt 84 (e.g., left handed threads, non-standard thread pitch, etc.), and a supply of epoxy 40. FIG. 16 also shows a set of plug removal tools 86. In this example, tools 86 include a standoff 88 and a nut 90 matching bolt 84.

One example method of using plug 38c involves creating an obstruction 92 on wire 28 to inhibit wire 28 from being pulled through plug 38c. Some examples of obstruction 92 include a knot 94 in wire 28, a knot 94 tying two wires 28 together, and/or a fastener 96 (e.g., a wire tie, a cable tie, a zip tie, etc.) on one or more wires 28.

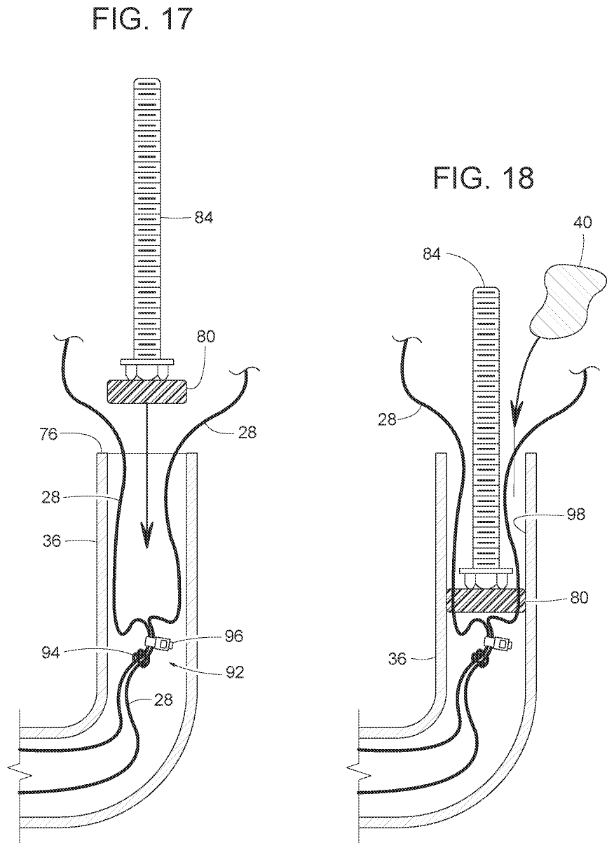

FIG. 17 shows inserting disk 80 and bolt 84 down into the upper end 76 of conduit 36 such that wire 28 extends through slits 82. In some examples, the head of bolt 84 can be glued to disk 80.

FIG. 18 shows epoxy 40 being poured into conduit 36 to encapsulate wires 28 and the lower end of bolt 84 and to bond to an inner wall 98 of conduit 36. Disk 80 compressively seals radially against the inner wall 98 of conduit 36 to help prevent liquid epoxy 40 from draining too far down conduit 36.

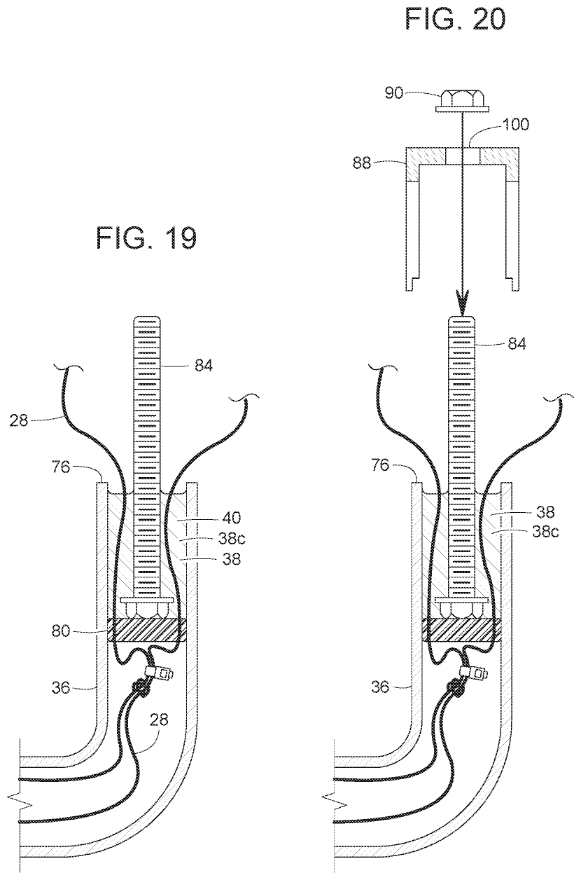

FIG. 19 shows the epoxy 40 having hardened to create plug 38c. Plug 38c bonds bolt 84 to conduit 36 with sufficient strength to prevent wire 28 (with its limited tensile strength) from being able to pull plug 38c out from within conduit 36.

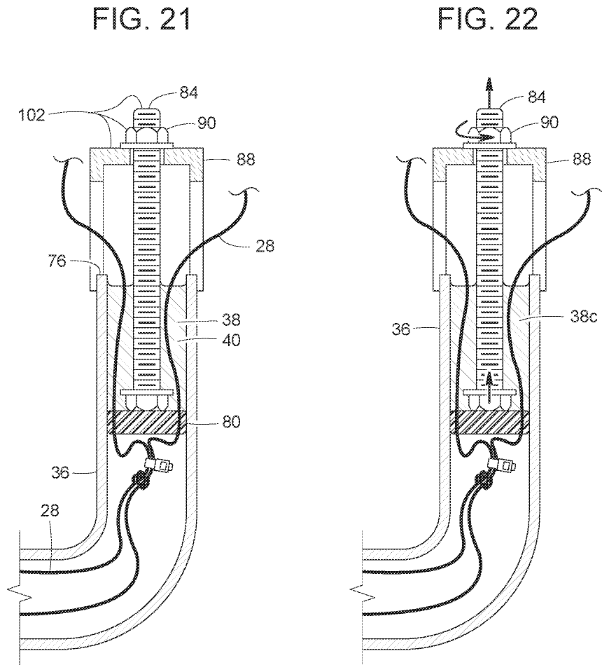

FIG. 20 shows an example method of removing plug 38c. In this example, standoff 88 is placed on the upper end 76 of conduit 36. Bolt 84 extends through a hole 100 in standoff 88, and nut 90 screws onto bolt 84. FIG. 21 shows standoff 88, bolt 84, and nut 90 configured to create a threaded plug puller 102 for removing plug 38c.

Bolt 84 and nut 90 being unconventional helps prevent a thief from readily using this method of removal. Standoff 88 and special nut 90 are, of course, made available to the entity overseeing the maintenance of the streetlights 12.

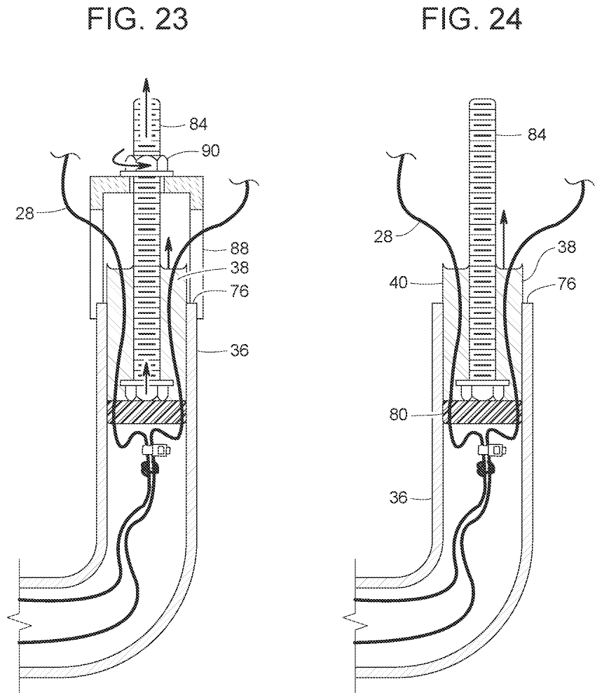

FIG. 22 shows nut 90 being turned to draw bolt 84 and plug 38c out from within conduit 36. Once plug 38c breaks loose of conduit 36, as shown in FIG. 23, bolt 84 and plug 38c can be manually pulled out completely without standoff 88 and nut 84, as shown in FIG. 24.

In a similar example, plug 38c is made mostly of metal instead of epoxy. Rather than using an adhesive bond between an epoxy version of plug 38c, a metal version of plug 38c can rely on a press-fit and/or include external threads or barbs that grip the inner wall 98 of conduit 36.

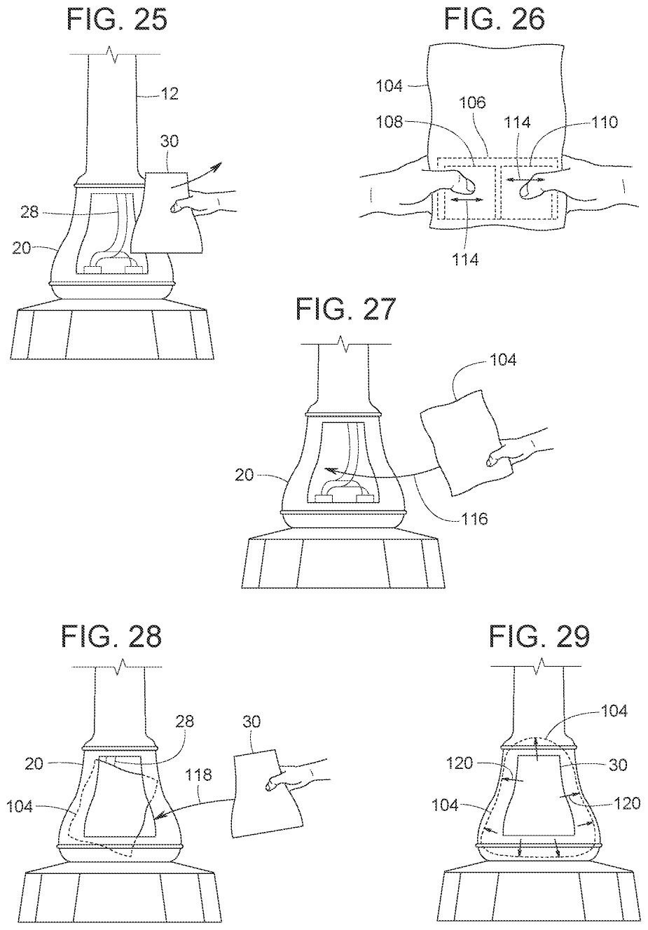

FIGS. 25-30 show another example structure and method for deterring theft of internal components (e.g., wires 28) of streetlight 12. In this example, a foam-expandable bag 104 is inserted in the base 20 of the streetlight 12. The bag 104 expands to fill much of the open space within base 20, thereby blocking access to the wires 28 and other internal components.

In some examples, as shown in FIG. 30, the bag 104 primarily fills just the space between the wires 28 and the cover plate 30, so if a thief removes the cover plate 30, it will appear that the base's entire chamber 32 is filled with foam when actually the base 20 is only partially full. A partially filled base 20 can deter thieves yet allows authorized personnel to remove the bag 104 with some effort to service the streetlight 12 as needed. When the foam is contained in the bag 104 once expanded, the foam may not encapsulate the wires and/or other internal components of the streetlight 12, and thus can reduce the effort needed by service personnel to remove the foam to service the streetlight 12.

FIG. 25 shows, in some examples, the process of at least partially filling the base 20 with foam begins by removing the cover plate 30 from the base 20. With the cover plate 30 removed, the foam-expandable bag 104 can be inserted into the base 20.

FIG. 26 shows an example foam-expandable bag 104. Some examples of foam-expandable bag 104 are provided by the Sealed Air Corporation of Charlotte, North Carolina. Some examples of the foam-expandable bag 104 are described in U.S. Pat. Nos. 5,899,325 and 6,712,201, both of which are incorporated herein by reference. Some examples of the foam-expandable bag 104 are known by various names such as, Instapack, Quick RT, Sealed Air Instapak Quick Room Temperature Foam Packaging, foam-in-bag systems, and variations and combinations thereof. These are just examples.

In the illustrated example, foam-expandable bag 104 includes an internal pouch 106 with two chambers 108 and 110. Chambers 108 and 110 are divided and hermetically sealed by a frangible seal between the two chambers 108 and 110. In some examples, chamber 108 contains a part-A component (e.g., isocyanate), and chamber 110 contains a part-B component (e.g., polyol).

The foam-expandable bag 104 can be activated by manual manipulation. Arrows 114 represent manually manipulating (e.g., pressing, patting, kneading, etc.) the foam-expandable bag 104 to break the frangible seal between the two chambers 108 and 110, thereby allowing the part-A and part-B components to intermix. The resulting mixture of part-A and part-B chemically reacts and expands as foam (e.g., polyurethane foam) that can spread throughout the bag 104.

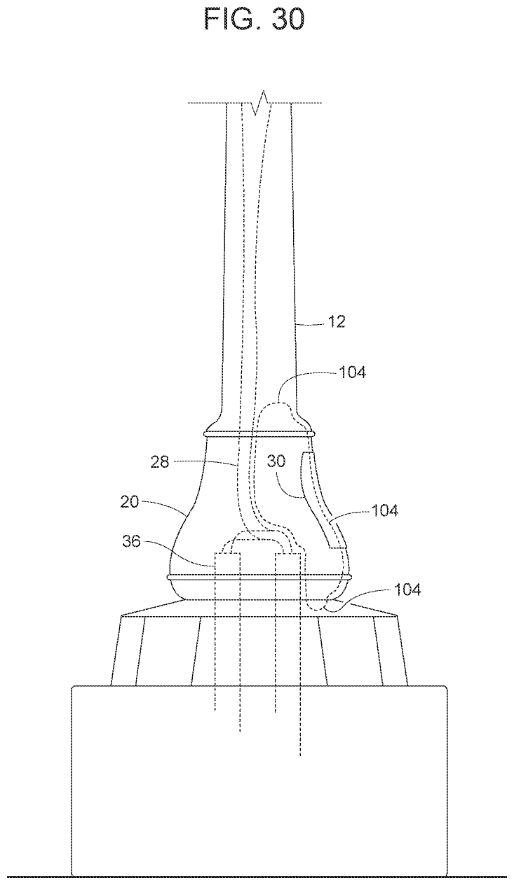

Before fully expanding, however, the foam-expandable bag 104 is quickly inserted in the base 20 (represented by arrow 116 of FIG. 27), and the cover plate 30 is held in place on the base 20 (represented by arrow 118 of FIG. 28). Arrows 120 of FIG. 29 represents the bag 104 continuing to expand within the base 20 while the cover plate 30 held in place.

After fully expanding, the foam in the bag 104 will set to at least a partially hardened state. The expanded, hardened foam makes it difficult to readily access the wires 28 and other internal components of the streetlight 12. With appreciable effort, however, the expanded bag 104 can be forcefully removed by service personnel to service the streetlight 12 if necessary.

Some apparatuses and methods associated with streetlight 12 can be defined by the following examples:

Example 1 A method for maintaining a streetlight, wherein the streetlight includes a base, a tubular pole extending upward from the base, a light fixture supported atop the tubular pole, and a conduit leading to the base; the method comprising: modifying the streetlight by installing a plug within at least one of the tubular pole and the conduit such that plug engages a plurality wires extending through at least one of the conduit and the tubular pole.

Example 2 The method of Example-1, wherein installing the plug involves installing the plug into the tubular pole.

Example 3 The method of Example-1, wherein installing the plug involves installing the plug into the conduit.

Example 4 The method of Example-1, wherein installing the plug involves injecting an expanding foam material into at least one of the tubular pole and the conduit.

Example 5 The method of Example-1, wherein the base defines a chamber, and the method further comprises filling most of the chamber with an expanding foam material.

Example 6 The method of Example-1, further comprising using a curved wand with a nozzle for injecting an expanding foam material into at least one of the tubular pole, the conduit, and a chamber defined by the base.

Example 7 The method of Example-1, wherein the plug is mostly comprised of metal.

Example 8 The method of Example-1, further comprising pulling the plug out from within the conduit by using a threaded plug puller.

Example 9 The method of Example-1, wherein the streetlight includes an electrical wire extending through the conduit and the tubular pole, and the method further comprising creating an obstruction on the electrical wire that inhibits the electrical wire from being pulled through the plug.

Example 10 The method of Example-9, wherein the obstruction includes a knot on the electrical wire.

Example 11 The method of Example-9, wherein the obstruction includes a fastener on the electrical wire.

Example 12 The method of Example-1, wherein the streetlight further includes a cover plate removably attached to the base, and the cover plate comprises a material that is different than that of the base.

Example 13 The method of Example-1, further comprising adding to the streetlight a sensor that produces an alarm signal in response to possible tampering of the streetlight.

Example 14 The method of Example-13, further comprising transmitting the alarm signal to a remote location.

Example 15 The method of Example-13, wherein the streetlight includes a cover plate removably attached to the base, and the sensor is responsive to removal of the cover plate.

Example 16 A method for maintaining a streetlight, wherein the streetlight includes a base defining a chamber therein, a removable cover plate attached to the base to cover the chamber, a tubular pole extending upward from the base, a light fixture supported atop the tubular pole, and a conduit leading to the base; the method comprising: removing the cover plate from the base; positioning an electrical wire within the tubular pole such that the electrical wire is spaced apart from the pole in a predetermined area; using a curved wand for injecting a foam material into the base and the tubular pole such that the foam material fills most of the chamber and engages the electrical wire at the predetermined area; and reattaching the cover plate to the base.

Example 17 The method of Example-16, wherein the cover plate comprises a material that is different than that of the base.

Example 18 The method of Example-16, further comprising adding to the streetlight a sensor that produces an alarm signal in response to possible tampering of the streetlight.

Example 19 The method of Example-18, further comprising transmitting the alarm signal to a remote location.

Example 20 The method of Example-18, wherein the sensor is responsive to removal of the cover plate.

Example 21 A streetlight comprising: a base defining a chamber therein; a removable cover plate attached to the base to cover the chamber; a tubular pole extending upward from the base; a light fixture supported atop the tubular pole; a conduit leading to the base; a foam material filling most of the chamber; and a notification attached to at least one of the tubular pole, the base and the removable cover plate; wherein the notification provides recognition of a sponsor that helps pay for maintaining the streetlight.

Example 22 The streetlight of Example-21, wherein the cover plate comprises a material that is different than that of the base.

Example 23 The streetlight of Example-21, further comprising a sensor attached to at least one of the base, the removable cover plate, the tubular pole and the light fixture; the sensor providing an alarm signal in response to possible tampering of the streetlight.

Example 24 The streetlight of Example-23, wherein the sensor is responsive to removal of the cover plate.

Example 25 A method for reducing theft of one or more internal components of a streetlight, wherein the streetlight includes a base, a cover plate for the base, a tubular pole extending upward from the base, and a light fixture supported by the tubular pole; the method comprising: removing the cover plate from the base, activating a foam-expandable bag, inserting the foam-expandable bag into the base, holding and/or reattaching the cover plate to the base, and allowing the foam-expandable bag to expand and harden within the base with the cover plate held in place on the base.

The disclosure should not be considered limited to the particular examples described above. Various modifications, equivalent processes, as well as numerous structures to which the disclosure can be applicable will be readily apparent to those of skill in the art upon review of the instant specification.

What is claimed is:

1. A method for reducing theft of one or more internal components of a streetlight, wherein the streetlight includes a base, a tubular pole extending upward from the base, a light fixture supported by the tubular pole, a conduit leading to the base, and a plurality of wires some of which extend out from an interior space of the conduit into an interior space of the base and through at least part of an interior space of the tubular pole to provide power to the light fixture, the method comprising:
providing an anti-theft material in an unsolidified state into the interior space of the base, the interior space of the tubular pole and/or the interior space of the conduit; and
providing the anti-theft material in the unsolidified state in at least part of the interior space of the base, the interior space of the tubular pole and/or the interior space of the conduit, wherein once provided, the anti-theft material solidifies to provide a deterrent to stealing one or more internal components of the streetlight.

2. The method of claim 1, wherein the anti-theft material comprises an expandable foam.

3. The method of claim 1, wherein the anti-theft material comprises a permanent ink.

4. The method of claim 1, wherein the streetlight comprises a cover plate removably attached to the streetlight to access the interior space of the base, the interior space of the tubular pole and/or the interior space of the conduit, the method comprises:
removing the removable cover plate to expose an access opening into the interior space of the base, the interior space of the tubular pole and/or the interior space of the conduit; and
providing the anti-theft material in the unsolidified state into the interior space of the base, the interior space of the tubular pole and/or the interior space of the conduit through the exposed access opening.

5. The method of claim 4, wherein after the anti-theft material is provided into at least part of the interior space of the base, tubular pole and/or conduit, securing the removable cover plate to the streetlight to re-cover the access opening.

6. The method of claim 4, wherein providing the anti-theft material comprising inserting a foam-expandable bag containing a foaming material that is in an unsolidified state into the base, tubular pole and/or conduit.

7. The method of claim 6, further comprising:
activating the foam-expandable bag to initiate expansion of the foaming material; and
after the foam-expandable bag is activated, securing the removable cover plate to the streetlight to re-cover the access opening before the foaming material completely expands and solidifies.

8. The method of claim 4, further comprising:
securing the removable cover plate to the streetlight to re-cover the access opening before the anti-theft material solidifies; and
after the removable cover plate is secured to the streetlight, the anti-theft material solidifies.

9. The method of claim 1, wherein the streetlight further comprises a sensor, the method comprising:
the sensor detecting a condition that corresponds to someone tampering with the streetlight; and
in response to the sensor detecting the condition that corresponds to someone tampering with the streetlight, providing the anti-theft material in the unsolidified state in at least part of the interior space of the base, the interior space of the tubular pole and/or the interior space of the conduit.

10. The method of claim 1, further comprising securing a notification plate to the streetlight, wherein the notification plate including indicia that identifies a designated sponsor of the streetlight.

11. The method of claim 1, wherein the streetlight further comprises a sensor, the method comprising:
the sensor detecting a condition that corresponds to someone tampering with the streetlight;
in response to the sensor detecting the condition that corresponds to someone tampering with the streetlight, initiating an alarm, wherein the alarm comprises one or more of:
an audible alarm;
a visual alarm;
a wired alarm signal that is transmitted to a remote location via a wired communication path; and
a wireless alarm signal that is transmitted to a remote location via a wireless communication path.

12. The method of claim 1, wherein the streetlight further comprises a sensor that is configured to detect a condition that corresponds to someone tampering with the streetlight, wherein the condition comprises one or more of:
a removal of a cover plate that provides access to the interior space of the base, the interior space of the tubular pole and/or the interior space of the conduit;
a predetermined motion profile of at least part of the streetlight;
a predetermined electrical profile of electrical signals on one or more of the plurality of wires;
a predetermined temperature change profile of at least part of the streetlight;
a predetermined sound profile associated with at least part of the streetlight; and
a predetermined light profile associated with the streetlight.

13. A method for reducing theft of one or more internal components of a streetlight, wherein the streetlight includes a base defining a chamber therein, a removable cover plate attached to the base to cover the chamber, a tubular pole extending upward from the base, a light fixture supported by the tubular pole, and a conduit leading to the base, the method comprising:
removing the cover plate from the base;
inserting a foam-expandable bag with a foam material that is in an unsolidified state into the base, the tubular pole and/or the conduit, wherein the foam-expandable bag is configured to expand and then solidify in the streetlight to provide a tamper resistance layer to one or more internal components of the streetlight; and
reattaching the cover plate to the base.

14. The method of claim 13, further comprising:
activating the foam-expandable bag before inserting the foam-expandable bag into the base, the tubular pole and/or the conduit; and
reattaching the cover plate to the base before the foam material of the foam-expandable bag completely expands and solidifies.

15. The method of claim 13, further comprising adding to the streetlight a sensor that produces an alarm signal in response to possible tampering of the streetlight.

16. The method of claim 15, further comprising transmitting the alarm signal to a remote location.

17. The method of claim 15, wherein the sensor is responsive to one or more of:
a removal of the cover plate;
a predetermined motion profile of at least part of the streetlight;
a predetermined electrical profile of electrical signals on one or more wires of the streetlight;
a predetermined temperature change profile of at least part of the streetlight;
a predetermined sound profile associated with at least part of the streetlight; and
a predetermined light profile associated with the streetlight.

18. A streetlight comprising:
a base defining a chamber therein;
a removable cover plate attached to the base to provide access to the chamber;
a tubular pole extending upward from the base;
a light fixture supported by the tubular pole;
a conduit leading to the base;
one or more electrical wires extending through the conduit, the base and at least part of the tubular pole to provide power to the light fixture; and
a solidified foam material hindering access to at least some of the electrical wires inside of the base, conduit and/or tubular pole.

19. The streetlight of claim 18, wherein the solidified foam material engages an inside surface of the removeable cover plate.

20. The streetlight of claim 19, wherein the solidified foam material is an expandable foam material that expanded from an unexpanded state to an expanded state inside of the base, conduit and/or tubular pole before solidifying.
